(19) United States
(12) Patent Application Publication
(10) Pub. No.: US 2010/0330910 A1
(43) Pub. Date: Dec. 30, 2010

(54) METHOD FOR TRANSMITTING AND RECEIVING DATA USING E-FIELD IN PORTABLE TERMINAL AND APPARATUS THEREOF

(75) Inventors: Long YAN, Suwon-si (KR); Chul Jin Kim, Yongin-si (KR); Jahng Sun Park, Seongnam-si (KR); Seok Yong Lee, Yongin-si (KR); Sae Rome Kim, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/821,561

(22) Filed: Jun. 23, 2010

(30) Foreign Application Priority Data
Jun. 25, 2009 (KR) 10-2009-0056895

(51) Int. Cl. H04B 7/00

(52) U.S. Cl. 455/41.2

(57) ABSTRACT

A method and apparatus are provided for transmitting and receiving data using an electric field. A first device determines whether a transmission path to a second device is formed through a part of a human body using an electric field. A connection is established with the second device through the transmission path by the first device, when the transmission path is formed through the part of the human body. Connection information for the second device is obtained through the transmission path by the first device. Data is transmitted from the first device to the second device using the obtained connection information of the second device.

### PRIORITY

This application claims priority under 35 U.S.C. 119(a) to an application filed in the Korean Intellectual Property Office on Jun. 25, 2009, and assigned Serial No 10-2009-0056895, the contents of which are incorporated herein by reference.

### BACKGROUND OF THE INVENTION

1. Field of the Invention

The present invention relates generally to a method of transmitting and receiving data using an electric field and an apparatus thereof, and more particularly, to a method of transmitting and receiving data using an electric field capable of transmitting and receiving data by selecting a target device without finding an apparatus in a local area network, and an apparatus thereof.

2. Description of the Related Art

Communication systems have been expanding to provide high-speed, large-scale multimedia services, such as data services and voice services. A plurality of devices can now share information in the communication system. Specifically, after a device accesses other desired devices, it can transmit information thereto. The device separately selects the other devices through a user's operation. The devices may share the information through one-to-one communication.

Various methods can be used to discover other devices according to a protocol of one-to-one communication.

When using Infrared Data Association (IrDA), an IrDA connection is established between two devices mounting Bluetooth and IrDA functions, and they exchange Bluetooth device discovery information.

Another method uses Near Field Communication (NFC). The NFC Forum defines interaction arrangements and procedures. These arrangements and procedures allow a device supporting two NFCS to establish connections using different wireless communication technology.

Wireless Fidelity (WiFi) or Bluetooth handover connection enables application deployment. The IrDA is advantageous in that any one device requires aim in the range of a circular cone angle of 30° toward an access point of another device for access. When the circular cone angle is less than 60°, a connection less than “line-of-sight” is not made.

When a device mounting a Bluetooth enters an inquiry sub-state to discover another Bluetooth device, device discovery and connection establishment procedures start. “Inquiry access codes” during an inquiry procedure in a Bluetooth standard classifies searched devices by types. For example, the types include a PSA, printer, or LAN access point.

According to the Bluetooth standard, when an inquirer does not receive a sufficient response or a previous inquiry sub-state does not stop, an inquiry sub-state continues for 10.24 seconds. In an environment with increased error, it is difficult to determine a maximum time necessary to discover a device. Moreover, it is impossible, in most cases, to consume a time longer than 10.24 seconds for discovering a device located at a specific zone.

After a determined time interval (typically 4 seconds) elapses or a fixed number of responses (typically two or three) are received, the inquiry stops.

Although such an approach is a short-term solution of an inquiry problem with respect to time restriction, when a Bluetooth device is disposed in a peripheral estimating zone, a consumer will be soon enclosed by the Bluetooth device. Therefore, when an inquiry procedure stops within 10.24 seconds, inquiry responses with respect to all devices disposed in all zones are not included. In the same manner, when a specific number of responses limit the number of inquiries, the inquiries are stopped before providing opportunity for a device to respond.

### SUMMARY OF THE INVENTION

The present invention has been made to address at least the above problems and/or disadvantages and to provide at least the advantages described below. Accordingly, an aspect of the present invention provides a communication method using an electric field that may intuitively select a desired device for data transmission through a human body's electric field according to one-to-one communication and an apparatus thereof.

Another aspect of the present invention provides a communication method using an electric field capable of reducing time consumption necessary for discovery of a desired device for data transmission according to one-to-one communication.

According to an aspect of the present invention, a method of transmitting data using an electric field is provided. A first device determines whether a transmission path to a second device is formed through a part of a human body using an electric field. A connection is established with the second device through the transmission path by the first device, when the transmission path is formed through the part of the human body. Connection information for the second device is obtained through the transmission path by the first device. Data is transmitted from the first device to the second device using the obtained connection information.

According to another aspect of the present invention, a method of receiving data using an electric field is provided. It is determined whether a transmission path to a second device is formed by a first device through a part of a human body using an electric field. A connection of the first device and the second device is established through the formed transmission path, when the transmission path is formed through the part of the human body. Connection information is generated by the second device and transmitted to the first device. Data transmitted from the first device is received through the transmission path.

According to an additional aspect of the present invention, an apparatus is provided for transmitting data using an electric field. The apparatus includes a first electrode unit that forms a transmission path with a second electrode unit of a second device using an electric field through a part of a human body, and an E-Field Communication (EFC) modem unit that transmits and receives data through the transmission path. The apparatus also includes a controller that determines whether the transmission path to the second device is formed using the electric field through the part of the human body, establishes a connection with the second device through the transmission path when the transmission path is formed, obtains connection information for the second device through the transmission path, and transmits data to the second device by using the obtained connection information.

According to a further aspect of the present invention, an apparatus for receiving data using an electric field is provided. The apparatus includes a first electrode unit that forms a transmission path with a second electrode unit of a second device using an electric field through a part of a human body, and an E-Field Communication (EFC) modem unit that transmits and receives data through the transmission path. The apparatus also includes a controller that determines whether the transmission path to the second device is formed using the electric field through the part of the human body, establishes a connection with the second device through the formed transmission path when the transmission path is formed, generates and transmits connection setting information for the connection with the second device, and receives data transmitted through the transmission path from the second device.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a drawing illustrating a configuration of a one-to-one communications system, according to an embodiment of the present invention;

FIG. 2 is a diagram illustrating a schematic configuration of a device, according to an embodiment of the present invention;

FIGS. 3a and 3b show execution screens of an application executing one-to-one data transmission and reception, according to an embodiment of the present invention;

FIG. 4 is a flow diagram illustrating a data transmission method, according to an embodiment of the present invention; and

FIG. 5 is a flow diagram illustrating a data reception method, according to an embodiment of the present invention.

### DETAILED DESCRIPTION OF EMBODIMENTS OF THE PRESENT INVENTION

Embodiments of the present invention are described in detail with reference to the accompanying drawings. The same or similar reference numbers may be used throughout the drawings to refer to the same or similar components. Detailed descriptions of constructions or processes known in the art may be omitted to avoid obscuring the subject matter of the present invention.

Embodiments of the present invention relates to a data communications method in which data is transmitted from one device to another device. Data is illustrated as a “photograph,” but it is not limited to this. In an embodiment of the present invention, data may include packet data, e.g., image data, text data and an audio signal. For example, data can be an eBook, a movie, and music. The configuration of a one-to-one communications system according to an embodiment of the present invention is described below.

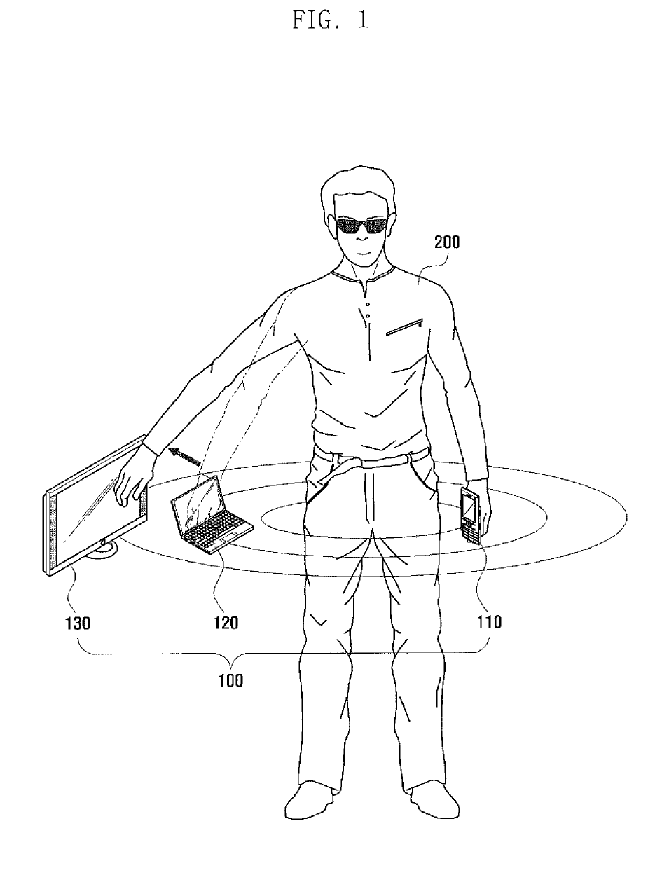

FIG. 1 is a drawing illustrating a configuration of the one-to-one communications system, according to an embodiment of the present invention.

The communications system sends and receives a signal through Electric Field Communications (EFC), e.g., human body communication. This communications system is comprised of a plurality of devices 100 (110, 120, 130) and a body 200.

By using a low-pass band having a near-field characteristic as a channel, the Electric Field Communications (EFC) delivers a signal to instruments connected to the human body, or a signal to a device through the air by using conductivity of the human body as a communications channel.

The devices 100 (110, 120, 130) can exchange a signal by using part of the body 200 as a transmission path. Specifically, an electric field is formed within a certain distance between one device selected from among devices 110, 120, 130 and the body 200. The signal can be sent to other devices 110, 120, 130 through this electric field. EFC uses a minute electric field, which is generated in the surface of the human body.

The embodiment of the present invention is technically separate from wireless and infra communication. The transmission path is instantaneously generated in a part of the human body connecting to an EFC transceiver. If the part of the human body is physically separated, the connection terminated. Accordingly, communications are also terminated. Communication is possible when EFC uses any kind of body surface such as hand, finger, arm, foot, leg, face, body or the like. EFC can also normally operate through footwear or clothing.

The devices 110, 120, 130 may include a Personal Digital Assistant (PDA), a portable Personal Computer (PC), a digital camera, an MP3 player, and a mobile phone. The body 200 can be a living body that can form an electric field. In communications with various mobile units and with a fixed instrument such as a printer, TV, an entry system and exit system, a communications path can be formed only with the intentional and simple contact of a user or only with the nearing of the instrument.

According to an embodiment of the present invention, when the user holds one device for data transmission, data for transmission is selected and a command for transmitting the corresponding data is inputted. If user selects a target device to which data is to be transmitted through part of the body of the user, a transmission path is formed and data can be transmitted to a corresponding device. The selection of the target device is provided through the part of the body of the user contacts with the target device or by approaching the target device with the one device for transmission. When performing the local wireless data communications using Bluetooth, there was a time error problem in searching neighboring Bluetooth devices and selecting a preferred device from among the searched Bluetooth devices.

In the data communications method according to an embodiment of the present invention, the user can immediately transmit data to the selected device by using part of the body without searching the neighboring Bluetooth devices. Specifically, the process of selecting a device by using a part of the body corresponds to the conventional process of searching devices and selecting a device using Bluetooth. Therefore, according to an embodiment of the present invention, the device searching process can be omitted in local wireless data communications.

A schematic configuration of above described device is illustrated. Hereinafter, a device for transmitting data is illustrated as a first device 110, and a device for receiving data is illustrated as a second device 120. However, the first or the second device can be one of the devices 110, 120, 130.

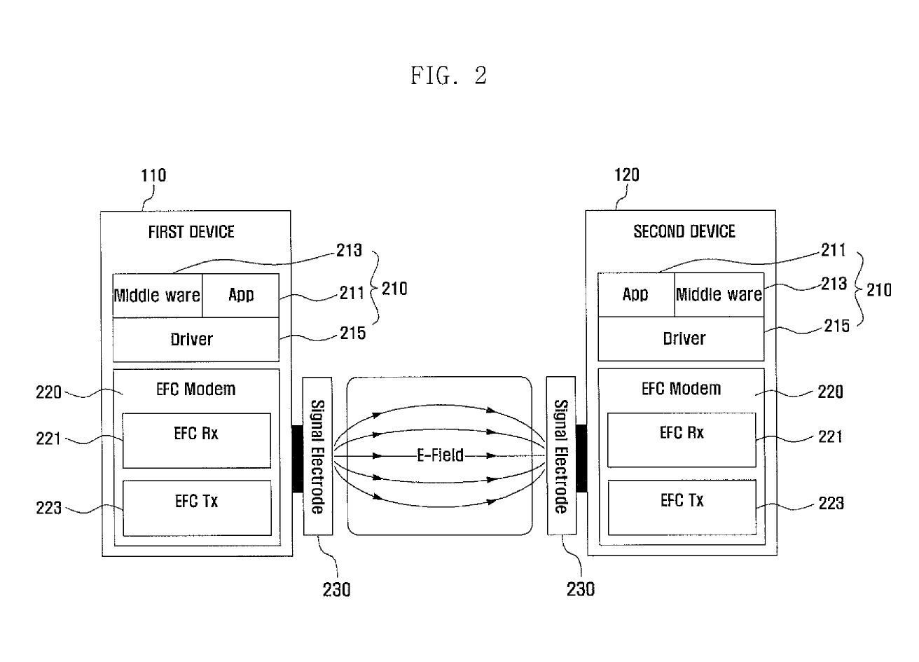

FIG. 2 is a diagram illustrating a schematic configuration of a device, according to an embodiment of the present invention.

In FIG. 2, the first and the second devices 110, 120 are shown, and one device can transmit and receive data with the other device according to EFC. Each device 110 and 120, according to an embodiment of the present invention, includes an application unit 210, an EFC modem unit 220 and an electrode unit 230.

If a communications path is fowled by using the electrode unit 230 and a part of the body 200, the devices 110 and 120 can transmit and receive data supported by the application unit 210 through the EFC modem unit 220.

The application unit 210 (or controller) controls the overall operation of a device according to an embodiment of the present invention. Specifically, the application unit 210 performs the function of processing data, and executes a command which corresponds to an interface provided to the user and an input of the user through such interface. Moreover, the application unit 210 operates the EFC modem unit 220 for the transmission/reception of data.

The application unit 210 includes an application module 211, a middleware module 213 and a driver 215. The application module 211 performs the function of processing data supported according to the kind of application. Processing data includes the storage, the display and the transmission of data. The middleware module 213 provides the communications of different protocols between the application unit 210 and the EFC modem unit 220. According to the request of the application module 211 or the middleware module 213, the driver 215 performs the role of operating the EFC modem unit 220.

The application unit 210 of the first device 110, i.e., the device transmitting data, determines whether a transmission path using an electric field to the second device 120 is formed through a part of the human body. When the transmission path is formed through a part of the human body, the application unit 210 establishes a connection with the second device 120 through the transmission path.

The application unit 210 of the first device 110 controls a series of transmitting a connection request message (EFC_Connection_Request) to the second device 120 and receiving a corresponding response. The application unit 210 of the first device 110 controls a series of obtaining connection information about the second device 120.

The application unit 210 of the first device 110 can generate a connection information request message and transmit it to the second device 120. The application unit 210 of the first device 110 transmits data to the second device 120 by using connection information, which the first device 110 obtained.

The second device 120, i.e., the device receiving data, determines whether a transmission path using the electric field is formed between the first device 110 and the second device 120 through a part of the human body. When the transmission path is formed through a part of the human body, the application unit 210 establishes a connection with the first device 110 through the formed transmission path.

The application unit 210 of the second device 120 receives a connection request message (EFC_Connection_Request) transmitted from the first device 110, and transmits a connection response (EFC_Connection_Response) message to the first device 110 as a corresponding response. Moreover, the application unit 210 of the second device 120 generates connection information for the second device 120 and send it to the first device 110.

The application unit 210 receives data transmitted from the first device 110 through the transmission path.

The EFC modem unit 220 includes a transmission unit 221, transmitting data according to the EFC technology, and a receiver 223, receiving data according to the EFC technology. The electrode unit 230 includes at least one electrode pair consisting of a signal electrode and a ground electrode. The electrode pairs are arranged in one or more directions in a device. The Electric Field (E-Field) is formed through the electrode unit 230.

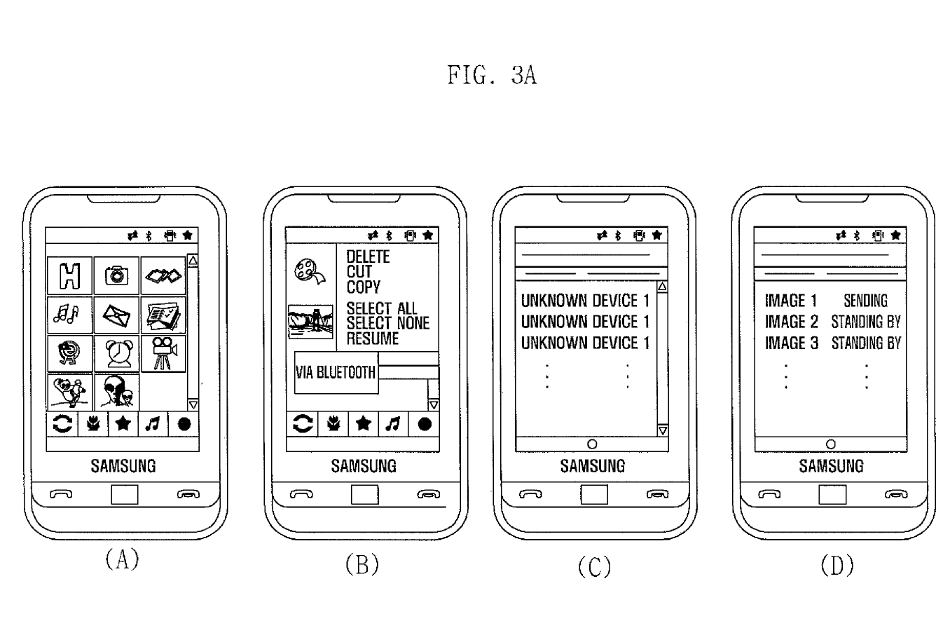

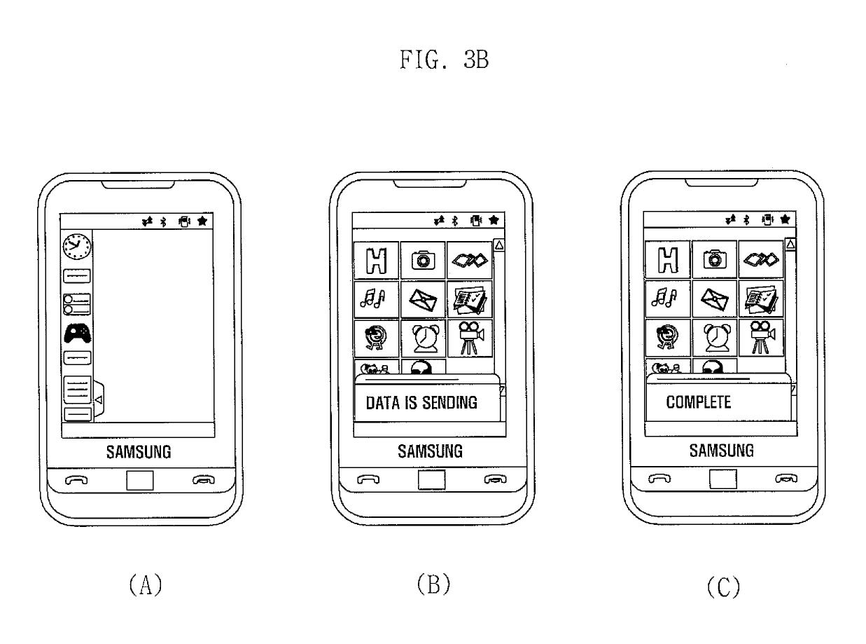

FIGS. 3A and 3B are execution screens of an application executing one-to-one data transmission and reception, according to an embodiment of the present invention.

Screens (A) to (D) are shown in FIG. 3A. It is assumed that the user desires to transmit an image by using Bluetooth. In an embodiment of the present invention, the procedure of using Bluetooth communications for data transmission is exemplified, but not limited thereto. An embodiment of the present invention can be applicable to all local area wireless communications in which one device can transmit data to another device by using a wireless and wired communications means, and, for example, may include an infrared communication, and Zigbee. Screen (A) is an execution screen of an application having a transmission function, and indicates a plurality of photographs with thumbnails. Moreover, when the user selects one photograph from among those in screen (A), screen (B) indicates a menu including a Bluetooth transmission function of a corresponding photograph. If a user transmits a corresponding photograph through Bluetooth, the user has to wait for the request and response of a Bluetooth device for 10 seconds according to a Blue tooth connection setting method. Neighboring devices are searched as shown in screen (C), and devices supporting Bluetooth are searched among neighboring devices, so that a list of the searched Bluetooth devices are indicated in screen (D). If the user selects one device from among the list of searched Bluetooth devices, the photograph is transmitted. According to an embodiment of the present invention, when a target device is selected through a part of the body, after one photograph is selected in screen (A) and user inputs a command of transmitting a corresponding photograph through Bluetooth in screen (B), the photograph is transmitted. Specifically, the process shown in the screen of (D) and (C) is omitted.

In FIG. 3B, the screens (A) to (C) are illustrated, which are screens of a device receiving data. If a transmission line is set by the selection of user, it is assumed that data transmission starts. Screen (A) shows a stand-by screen, and screen (B) shows a screen in which data transmission has progressed. Screen (C) is a screen which informs that data transmission has completed.

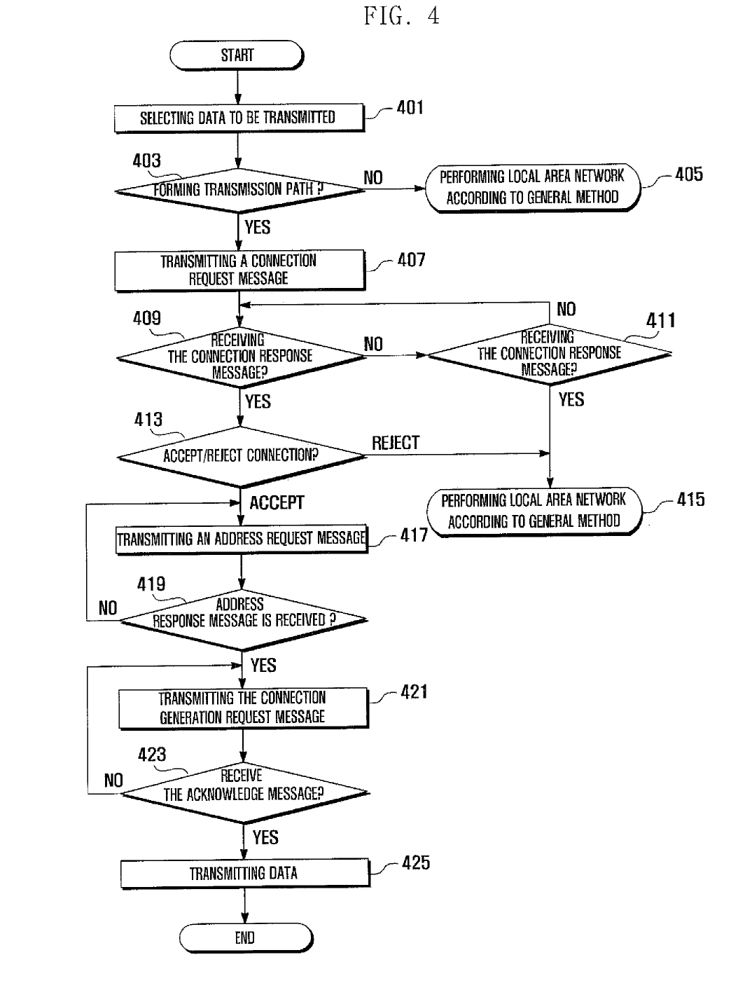

FIG. 4 is a flow diagram illustrating a data transmission method, according to an embodiment of the present invention.

In FIG. 4, it is assumed that the first device 110 is a device for transmitting data, and the second device 120 is a device for receiving data. It is also assumed that the first device 110 is in the state where photographs are displayed as shown screen (A) of FIG. 3A. It is assumed that data for transmission is selected by the user and data transmission is requested by the user. If data to be transmitted is selected in step 401, the first device 110 determines whether a transmission path with the second device 120 is formed in step 403.

The second device 120 is a device selected through a part of the body of the user. The transmission path becomes an electric field according to the electric field communications of the human body. When the user selects the second device 120 by using a part of the body while grasping the first device 110, a transmission path is formed between the first device 110 and the second device 120. The selection can mean the process of contacting the second device 120 by using a part of the body while grasping the first device 110, or nearing the second device 120 at a given distance. When a transmission path is not formed, the first device 110 transmits data by using a local area network according to a general method in step 405.

When the transmission path is formed, the first device 110 transmits a connection request (EFC_Connection_Request) message to the second device 120 in step 407. The first device 110 transmitting the connection request (EFC_Connection_Request) message stands by until reception of the connection response (EFC_Connection_Response) message corresponding to the connection request message from the second device 120 in step 409. The first device 110 stands by for the reception of the connection response message for a preset maximum standby time in step 411. When the maximum standby time is exceeded, the first device 110 transmits data by using a local area network according to the general method in step 415.

The connection response (EFC_Connection_Response) message has a parameter indicating the acceptance result of the second device 120. Therefore, if the connection response (EFC_Connection_Response) message is received, the first device 110 determines whether the content indicated by the connection response message accepts connection in step 413. When the connection is accepted, the first device 110 proceeds to step 417. When the connection is rejected, the first device 110 proceeds to step 415. Specifically, in the conventional method the first device 110 transmits an inquiry for searching for neighboring devices (send HCI_Inquiry CMD), and this inquiry is continued until the address of the second device 120 is received (Receive BD_ADDR).

When the connection is accepted through the connection response (EFC_Connection_Response) message, the first device 110 transmits a connection information request message requesting the connection information of the second device 120 in step 417. The connection information request message can be an address request (BT_Addr_Request) message requesting the address of the Bluetooth of the second device 120. However, the connection information can also include an Medium Access Control (MAC) address, encryption information, and a public key, and the same principles can be applied.

The first device 110 confirms whether a connection information response message is received as a response for a connection information request of the first device 110 in step 419. If the connection information request message is an address request message, the connection information response message can be an address response (BT_Addr_Response) message. If the first device 110 receives the connection information from the second device 120, the first device 110 transmits a connection generation request message to the second device 120 by using the address information of the second device 120 included in the connection information in step 421. If the first device 110 does not receive the connection information from the second device, the first device 110 returns to step 417 and retransmits the address request message.

When the connection information is the BT address of the second device, the first device 110 transmits the connection generation request (BT_Create_Connection) message by using the BT address to the second device 120. According to the connection generation request (BT_Create_Connection) message, if an acknowledge (Ack) message is received from the second device 120, connection is successfully established. Accordingly, if the first device 110 receives the acknowledge (Ack) message from the second device 120 in step 423, the first device 110 transmits data in step 425. If the first device 110 does not receive the acknowledge (Ack) message from the second device, the first device 110 returns to step 421 and retransmits the connection generation request message to the second device 120.

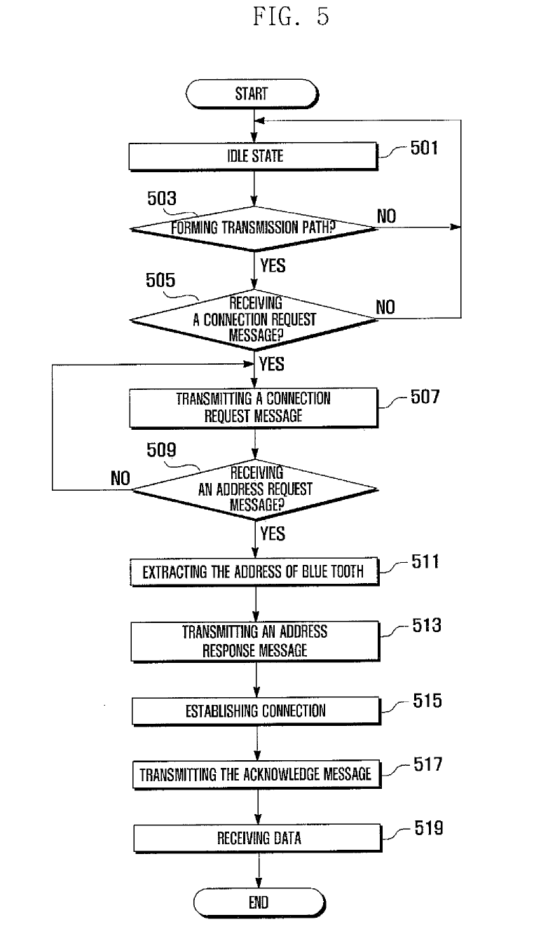

FIG. 5 is a flow diagram illustrating a data reception method, according to an embodiment of the present invention.

In FIG. 5, like FIG. 4, it is assumed that the first device 110 is a device for transmitting data, and the second device 120 is a device for receiving data. It also is assumed that the second device 120 is in a standby state (Idle State) in step 501. It is further assumed that the user selects the second device 120 for data transmission by using a part of the body while grasping the first device 110. A transmission path is formed between the first device 110 and the second device 120. If the transmission path is formed between the second device 120 and the first device 110, the second device 120 is able to receive data from the first device 110 by using an electric field as a transmission path in step 503. Accordingly, when the second device 120 receives a connection request (EFC_Connection_Request) message in step 505, it transmits a connection response (EFC_Connection_Response) message as a corresponding response in step 507. It is assumed that the second device 120 transmitted a connection response (EFC_Connection_Response) message having an acknowledge response. The second device 120 confirms whether the connection information request message is received from the first device 110 in step 509. As described above, according to an embodiment of the present invention, the connection information request message can be an address request (BT_Addr_Request) message requesting a Bluetooth address of the second device 120.

If the second device 120 does not receive the connection information request message in step 509, then the second device 120 returns to 507 and retransmits the connection request message.

If the connection information request message is received in step 509, the second device 120 generates necessary connection information in order to connect the first device 110 with the second device 120 in step 511. The connection information can include at least one selected from among Blue tooth address of the second device 120, Medium Access Control (MAC) address, encryption information, a public key. Particularly, the second device 120 can use “GetMyBTAddr( )” function in order to extract its own Bluetooth address. If the connection information generation is completed, the second device 120 transmits a connection information response message including the connection information generated at step 511 to the first device 110, in step 513. When the connection information is the Bluetooth address of the second device 120, the connection information response message can be an address response (BT_Addr_Response) message having the Bluetooth address of the second device 120. The first device 110 obtains the address of the device 120 through the connection information. The first and second devices 110, 120 establish connection in step 515. If connection is established, the second device 120 transmits the acknowledge (Ack) message to the first device 110 in step 517. The second device 120 receives data in step 519. As described above, according to an embodiment of the present invention, a target device is selected by using a part of the body to transmit data. Accordingly, one-to-on communications can be performed without finding neighboring devices or inquiring with the target device.

While the invention has been shown and described with reference to certain embodiments thereof, it will be understood by those skilled in the art that various changes in form and detail may be made therein without departing from the spirit and scope of the present invention, as defined by the appended claims.

What is claimed is:

1. A method of transmitting data from a first device using an electric field, comprising the steps of:
determining whether a transmission path to a second device is formed through a part of a human body using an electric field, by the first device;
connecting with the second device through the transmission path, by the first device, when the transmission path is formed through the part of the human body;
obtaining connection information for the second device through the transmission path, by the first device; and
transmitting data from the first device to the second device using the obtained connection information of the second device.

2. The method of claim 1, wherein it is determined whether the transmission path is formed, when a user of the first device selects the second device by using the part of the human body while grasping the first device.

3. The method of claim 1, wherein the first device connects with the second device by transmitting a connection request message from the first device to the second device.

4. The method of claim 1, wherein the connection information comprises at least one of Bluetooth address information of the second device, Medium Access Control (MAC) address information, encryption information, and a public key.

5. The method of claim 4, wherein, after obtaining the connection information, further comprising:
transmitting a Bluetooth connection generation request message from the first device to the second device using the Bluetooth address information of the second device; and
receiving a Bluetooth connection generation response message from the second device and setting the Bluetooth connection by the first device.

6. A method of receiving data using an electric field, comprising the steps of:
determining whether a transmission path is formed by a first device to a second device through a part of a human body using an electric field;
connecting the first device and the second device through the formed transmission path, when the transmission path is formed through the part of the human body;
generating connection information by the second device and transmitting the connection information to the first device; and
receiving data transmitted from the first device at the second device through the transmission path.

7. The method of claim 6, wherein it is determined whether the transmission path is formed, when a user selects the second device by using the part of the human body while grasping the first device.

8. The method of claim 6, wherein connecting the first device and the second device comprises:
receiving a connection request message transmitted from the first device by the second device; and
transmitting a connection response EFC Connection Response message to the first device by the second device.

9. The method of claim 6, wherein the connection information comprises at least one of Bluetooth address information of the second device, Medium Access Control (MAC) address information, encryption information, and a public key.

10. The method of claim 9, wherein after generating and transmitting the connection information, further comprising:
transmitting a Bluetooth connection generation response message to the first device and setting a Bluetooth connection in response to a Bluetooth connection generation request message transmitted from the first device, by the second device.

11. An apparatus for transmitting data using an electric field, comprising:
an first electrode unit that forms a transmission path with a second electrode unit of a second device using an electric field through a part of a human body;
an E-Field Communication (EFC) modem unit that transmits and receives data through the transmission path; and
a controller that determines whether the transmission path to the second device is formed using the electric field through the part of the human body, establishes a connection with the second device through the transmission path when the transmission path is formed, obtains connection information for the second device through the transmission path, and transmits data to the second device by using the obtained connection information.

12. The apparatus of claim 11, wherein the controller determines that the transmission path is formed, when the user selects the second device by using the part of the human body while grasping the apparatus.

13. The apparatus of claim 11, wherein the controller establishes the connection by transmitting a connection request message to the second device.

14. The apparatus of claim 11, wherein the connection information comprises at least one of Bluetooth address information of the second device, Medium Access Control (MAC) address information, encryption information, and a public key.

15. The apparatus of claim 14, wherein the controller transmits a Bluetooth connection generation request message to the second device by using the Bluetooth address information of the second device, and receives a Bluetooth connection generation response message from the second device to set a Bluetooth connection.

16. An apparatus for receiving data using an electric field, comprising:
an first electrode unit that forms a transmission path with a second electrode unit of a second device using an electric field through a part of a human body;
an E-Field Communication (EFC) modem unit that transmits and receives data through the transmission path; and
a controller that determines whether the transmission path to the second device is formed using the electric field through the part of the human body, establishes a connection with the second device through the formed transmission path when the transmission path is formed, generates and transmits connection setting information for the connection with the second device, and receives data transmitted through the transmission path from the second device.

17. The apparatus of claim 16, wherein the controller determines that the transmission path is formed, when a user selects the apparatus by using the part of the human body while grasping the second device.

18. The apparatus of claim 16, wherein the controller transmits a connection response (EFC_Connection_Response) message to the second device when receiving a connection request message transmitted from the second device, for establishing the connection.

19. The apparatus of claim 16, wherein the connection information comprises at least one of Bluetooth address information of the apparatus, Medium Access Control (MAC) address information, encryption information, and a public key.

20. The apparatus of claim 19, wherein the controller transmits a Bluetooth connection generation response message to the second device and establishes a Bluetooth connection in response to a Bluetooth connection generation request message transmitted from the second device.
